(19) United States
(12) Patent Application Publication
(10) Pub. No.: US 2017/0016318 A1
(43) Pub. Date: Jan. 19, 2017

(54) METHOD AND APPARATUS FOR COMMUNICATION OF WELLBORE DATA, INCLUDING VISUAL IMAGES

(71) Applicants: MARSHAL HARRIS, HOUSTON, TX (US); CHRISTOPHER MEYERS, YOUNGSVILLE, LA (US); PHIL SCHULTZ, KATY, TX (US)

(72) Inventors: MARSHAL HARRIS, HOUSTON, TX (US); CHRISTOPHER MEYERS, YOUNGSVILLE, LA (US); PHIL SCHULTZ, KATY, TX (US)

(73) Assignee: ABRADO, INC., HOUSTON, TX (US)

(21) Appl. No.: 15/281,915

(22) Filed: Sep. 30, 2016

Related U.S. Application Data
(63) Continuation of application No. 14/204,159, filed on Mar. 11, 2014, now abandoned.
(60) Provisional application No. 61/776,233, filed on Mar. 11, 2013.

(51) Int. Cl. E21B 47/12; H04Q 9/00; E21B 47/00; E21B 17/20; E21B 23/08; E21B 47/01

(52) U.S. Cl. CPC E21B 47/122; E21B 23/08; E21B 47/011; E21B 47/0002; E21B 17/20; H04Q 9/00; H04Q 2209/40; H04Q 2209/88

(57) ABSTRACT

A wireless communication assembly permits convenient and effective communication between down hole logging and/or data storage tools conveyed via non-conductive wireline and surface equipment, including while such tools are situated within a lubricator, wellhead or other surface equipment. Data acquired by a down hole logging or data storage tool is transmitted to a wireline-conveyed communication assembly, and then wirelessly transmitted to a surface data communication assembly. Thereafter, such data can then be acquired, displayed and/or downloaded via an external data port on said surface data communication assembly using a wired or wireless connection.

### CROSS REFERENCES TO RELATED APPLICATIONS

THIS APPLICATION IS A CONTINUATION OF U.S. patent application Ser. No. 14/204,159, FILED Mar. 11, 2014, CURRENTLY PENDING, WHICH CLAIMS PRIORITY OF U.S. PROVISIONAL PATENT APPLICATION Ser. No. 61/776,233, FILED Mar. 11, 2013, ALL INCORPORATED HEREIN BY REFERENCE.

### STATEMENTS AS TO THE RIGHTS TO THE INVENTION MADE UNDER FEDERALLY SPONSORED RESEARCH AND DEVELOPMENT

NONE

### BACKGROUND OF THE INVENTION

1. Field of the Invention

The present invention pertains to wireless communication of data. More particularly, the present invention pertains to wireless transmission of logging data acquired through the use of borehole logging tools in wells. More particularly still, the present invention pertains to the wireless transmission of data exchange at a well's surface without the need to disassemble or restructure lubricators, surface pressure containment devices or other surface equipment.

2. Brief Description of the Prior Art

Whether a well is in the process of being drilled, or is already producing, it is often advantageous to utilize various types of wireline-conveyed tools to perform various functions within such well. Such wireline conveyed tools are typically lowered into a well from the surface, and suspended/manipulated within said well using a flexible wireline or cable; excess wireline is taken up or let out from a spool or drum at the surface. In most instances, the leading end of such spooled wireline is removed from the spool, vertically aligned over a well and suspended in place using an arrangement of strategically positioned sheaves or pulleys.

A pressure containment device commonly referred to as a “lubricator” is typically used at the surface when performing various wireline services in cased or open hole well operations. The lubricator assembly, which is usually attached to the top of a tree (in the case of a producing well) or blowout preventer assembly (in the case of a well that is being drilled), typically comprises a tubular housing having an inner chamber of sufficient diameter and length to completely contain the wireline tool(s) being used.

When it becomes necessary to remove and disassemble wireline-conveyed tools (such as after operations are performed), the tools can be raised out of the well and into the lubricator. Once the tools are safely inside the lubricator, the valve(s) of a tree (in the case of a producing well), or the rams of the blowout preventers (in the case of a well that is being drilled), can be closed to seal off or isolate such pressure from the lubricator. With the well pressure safely contained below the tree valves or blowout preventer assembly, any trapped fluid pressure can be relieved from the lubricator. Thereafter, the lubricator can then be disassembled, permitting access to such wireline-conveyed tools.

It is frequently advantageous to obtain information concerning down hole wellbore conditions or geologic formations penetrated by a well. Such information is often obtained using logging tools that are conveyed in and out of a well via wireline. In some cases, such wireline—commonly referred to as “electric line”—can permit the flow of electricity and transmission of data. In other cases, non-conductive wireline known as “slickline” is used for this purpose; although use of slickline or other non-conductive wireline can be much less expensive than electric line, such slickline or non-conductive wireline does not allow data or electrical current to be conveyed through such wireline.

Unfortunately, the use of down hole logging tools frequently suffers from a variety of different problems. For example, retrieved data from logging tools is often not fit for its intended purpose due to data corruption, tool malfunction, technical or operational failure. When logging tools are conveyed using electric line, the existence and scope of such problems is often known in real time including, without limitation, before such tools have been retrieved from a well. By contrast, when logging tools are conveyed on slickline or other non-conductive wireline, the existence and/or severity of such problems is typically not known until the tools are retrieved from a well and the tools are physically accessed.

In order to physically access such logging tools, said logging tools must first be retrieved to the surface via wireline. Thereafter, any trapped fluid pressure must be relieved from a lubricator, and the lubricator must be disassembled in order to permit physical access to such logging tools. Once such logging tools are accessed, data can be downloaded, verified and/or reprogrammed directly from such logging tools. If data is determined as unfit for any reason, the logging tool must be repaired or reset, and the lubricator or other surface pressure containment device must be reassembled. Thereafter, the logging tool must be conveyed into the well and the logging run repeated until usable date is obtained or the effort is abandoned. The process can be time consuming and expensive.

Memory cameras and/or video logging devices capable of recording visual images are commonly conveyed in and out of wells using slickline or other non-conductive wireline. As with other wireline conveyed tools, such cameras or other devices are deployed into the upper portion of a well and a valve is typically opened in order to bleed off or relieve any fluid pressure trapped in a lubricator. During this process, oil, grease and/or other debris can often be projected onto the lens of the camera or other video device, thereby limiting the effectiveness of said tool. In such cases, the memory camera or video logging device must be thoroughly cleaned or replaced, resulting in additional downtime and expense.

Thus, there is a need for a means to communicate with wireline-conveyed logging tools prior to disassembling a lubricator or surface pressure containment device, and physically accessing such logging tools. Such communication means can be used to verify that acquired visual images and/or other logged data is satisfactory. Moreover, operational parameters (for example, acquisition of a ‘snapshot’ image at the surface to confirm existence of a clean lens on a video logging tool) can be verified prior to making an initial logging run, ensuring a higher chance of a successful operation at the outset. If additional data is required, a supplementary logging run can be made without the need for physically accessing such tool. Further, such communication means should overcome limitations associated with conventional well surface equipment that typically includes fittings and fixtures that restrict or prevent wireless communication.

### SUMMARY OF THE INVENTION

The present invention comprises a method and apparatus for improved efficiency during well logging operations. More specifically, the present invention permits convenient and effective communication between logging tools conveyed on non-conductive wireline and surface equipment, including while such tools are located within a drill-string, lubricator, wellhead or other surface equipment.

The internal spaces of a wellbore and wireline surface equipment infrastructure present a relatively closed system that is generally resistant to wireless communication to and from the outside of said system. In a preferred embodiment, the present invention comprises an antenna located at a well's surface for the purpose of communicating with an in-line antenna sub or other communication device attached to or associated with borehole logging tools.

Said surface antenna and an in-line antenna sub are physically separated from one another, yet remain within the aforementioned closed system. In a preferred embodiment, said surface antenna and in-line antenna sub can be beneficially positioned with mutual line of sight, such that wireless communication signals may be sent and received between the said components. The antenna pair permit wireless communication and data transfer and are fully adaptable and configurable to many different types of data transfer protocol and programming languages.

By permitting convenient and effective communication between logging tools conveyed on non-conductive wireline and surface equipment, including while such tools are located within a drill-string, lubricator, wellhead or other surface equipment, operational status of logging tools and the quality of acquired data can be verified without the need to rig down, disassemble or reconfigure lubricators or other surface interface equipment. Further, if a tool is determined to be unfit or not working properly, troubleshooting and remediation may be performed wirelessly prior to making a logging run, thereby saving time and expense.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

### BRIEF DESCRIPTION OF DRAWINGS/FIGURES

The foregoing summary, as well as any detailed description of the preferred embodiments, is better understood when read in conjunction with the drawings and figures contained herein. For the purpose of illustrating the invention, the drawings and figures show certain preferred embodiments. It is understood, however, that the invention is not limited to the specific methods and devices disclosed in such drawings or figures.

FIG. 1 depicts a side perspective view of a surface communication assembly of the present invention installed atop a conventional lubricator and wellhead assembly.

FIG. 2 depicts a side sectional view of a surface communication assembly of the present invention.

FIG. 3 depicts a wireline-conveyed communication assembly of the present invention.

FIG. 4 depicts a side sectional view of a surface communication assembly and wireline-conveyed communication assembly of the present invention in beneficial alignment.

### DETAILED DESCRIPTION OF A PREFERRED EMBODIMENT

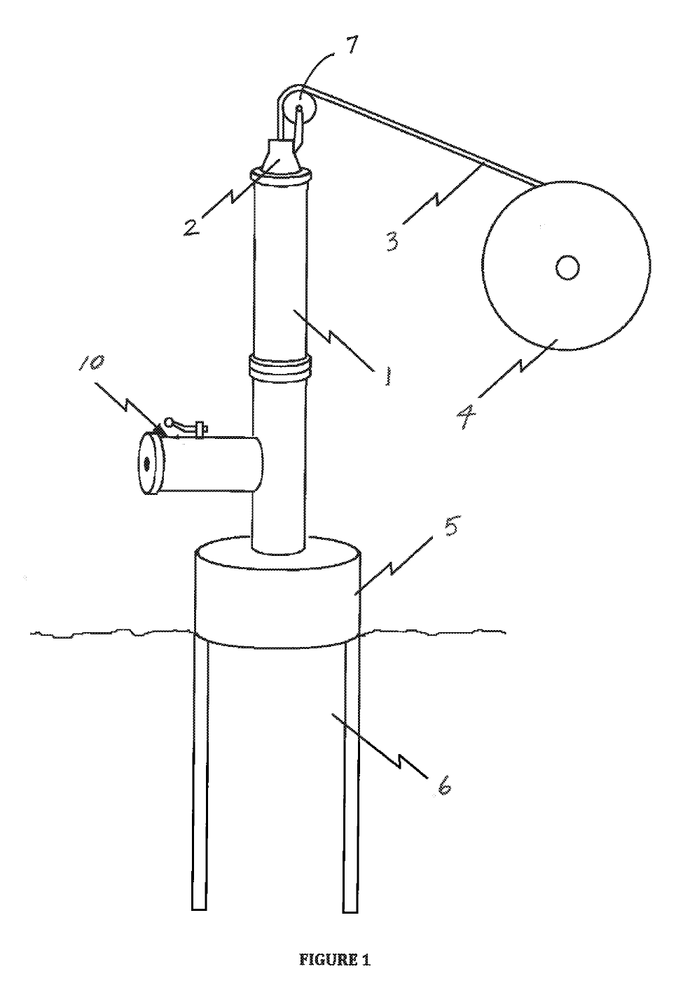

In the following description, like reference numerals refer to like or corresponding elements among the figures. FIG. 1 depicts a side perspective view of a surface communication assembly 10 of the present invention installed below a conventional lubricator assembly 1 and atop a wellhead assembly 5. As depicted in FIG. 1, surface communication assembly 10 is installed above wellhead assembly 5 which, in turn, is installed above wellbore 6. Wireline cable 3 extends from spool 4 over sheave 7 and through stuffing box 2 installed on lubricator assembly 1. Wireline-conveyed tools connected to the leading end of wireline cable 3 can be lowered into wellbore 6 from the earth's surface, and suspended/manipulated within said wellbore 6 using said flexible wireline cable 3.

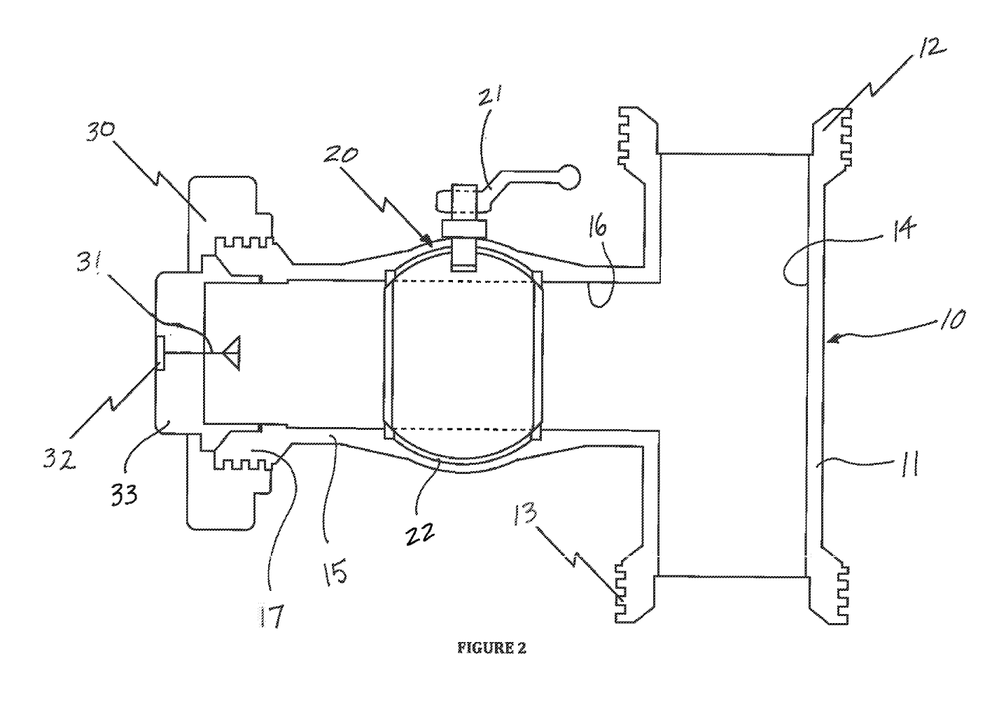

FIG. 2 depicts a side sectional view of surface communication assembly 10 of the present invention. Surface communication assembly 10 generally comprises central body member 11 defining a housing having central through bore 14, as well as upper threaded connection 12 and lower threaded connection 13. In a preferred embodiment, upper threaded connection 12 can be used to connect surface communication assembly 10 to a lubricator assembly (such as, for example, lubricator assembly 1 depicted in FIG. 1), while lower threaded connection 13 can be used to connect surface communication assembly 10 to a wellhead (such as, for example, wellhead assembly 5 depicted in FIG. 1).

Peripheral extension member 15 having central through bore 16 and outer threaded connection 17 extends from central body member 11, typically from a side of said central body member 11. In a preferred embodiment, through bore 16 of said peripheral extension member 15 is in communication with central through bore 14 of body member 11; put another way, through bore 16 of peripheral extension member 15 opens into central bore 14 of body member 11.

Double sealing valve assembly 20 is disposed between body member 11 and outer threaded connection 17. In a preferred embodiment, said double sealing valve assembly 20 comprises handle 21 and internal ball member 22. By turning handle 21, internal ball member 22 can be rotated. In this manner, valve assembly 20 is capable of selectively controlling fluid flow through bore 16 of peripheral extension member 15. When desired, internal ball member 22 of valve assembly 20 can be closed to provide a fluid-pressure seal between central bore 14 of body member 11 and outer threaded connection 17 of peripheral extension member 15.

Hammer union antenna cap assembly 30, having an internal threaded section, is removably secured to outer threaded connection 17 of side member 15. In a preferred embodiment, said hammer union antenna cap assembly 30 comprises communication sub 33 equipped with a data receiver and transmitter, antenna 31 and external data port 32. Antenna 31 is beneficially arranged to have a substantially direct and unobstructed line of sight with central through bore 14 of body member 11 when valve assembly 20 is in an open position. External data port 32, which is electrically connected to communication sub 33 and/or antenna 31, is accessible from the external surface of hammer union cap assembly 30.

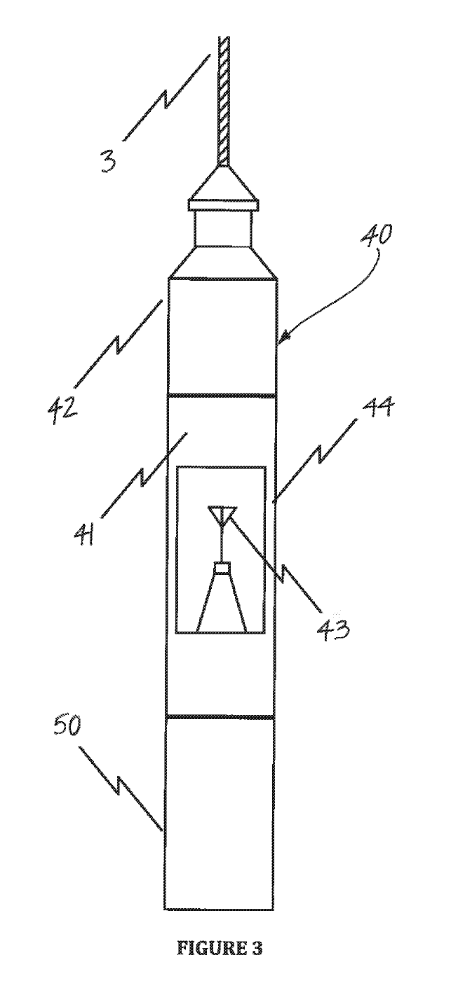

FIG. 3 depicts a wireline-conveyed communication assembly 40 of the present invention. In a preferred embodiment, in-line communication sub 41 is attached below conventional wireline cable head 42 which can be conveyed in and out of a well via flexible wireline cable 3. Logging tool 50 is attached to, and in electrical connection with, in-line communication sub 41 having a data transmitter and receiver. It is to be observed that logging tool 50 can comprise any number of different down hole data sensing and/or recording devices well know to those having skill in the art including, without limitation, a down hole camera, optical sensor or video recording device, magnetometers, accelerometers, pressure and temperature sensing devices or any array of down hole logging instrumentation. Antenna 43 is disposed within in-line communication sub 41 and protected from damage and/or direct contact by surrounding protection cage 44.

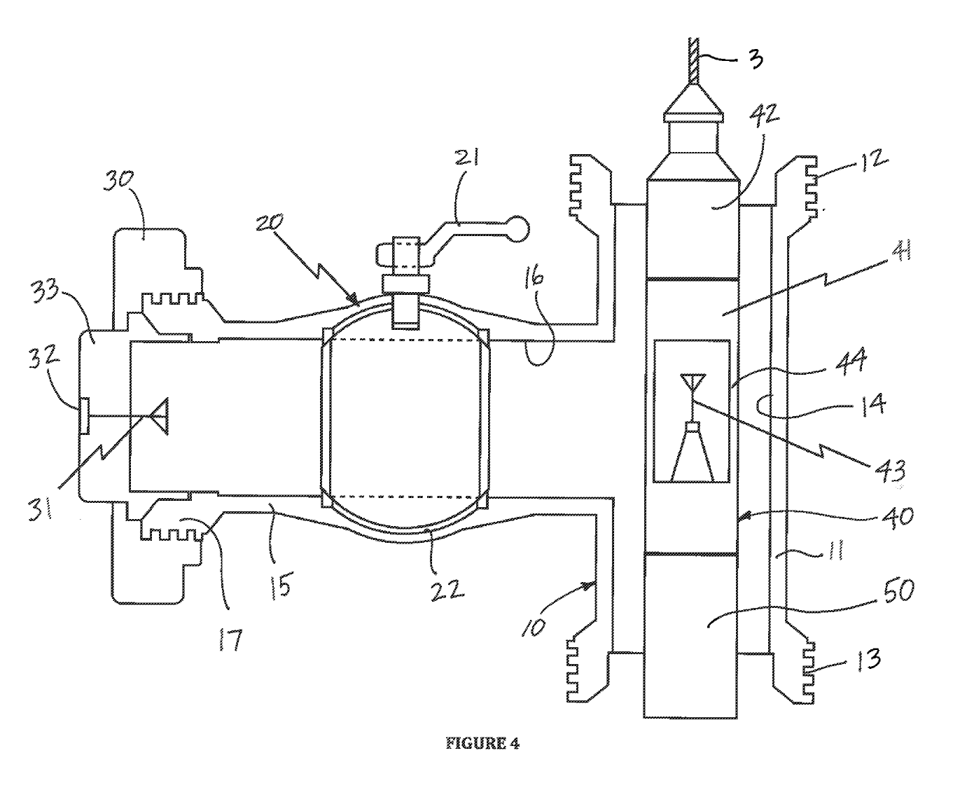

FIG. 4 depicts a side sectional view of a surface communication assembly 10 together with beneficially aligned wireline-conveyed communication assembly 40. As depicted in FIG. 4, for optimal communication conditions between surface antenna 31 and wireline-conveyed antenna assembly 43, a substantially direct and unobstructed line of sight between said antennas 31 and 43 can be beneficially established, with valve assembly 20 in an open position. Surface antenna 31 of surface antenna assembly 10 is capable of transmitting data to, and receiving data from, wireline-conveyed antenna 43 of wireline-conveyed communication assembly 40. FIG. 4 depicts wireline-conveyed antenna 43 of wireline-conveyed communication assembly 40 advantageously positioned relative to surface antenna 31 of surface communication assembly 10.

In operation, logging tool 50 (such as, for example, a down hole pressure gauge, memory camera, video recording device or other logging apparatus capable of sensing and/or recording data) is suspended from, and can be conveyed within a well using, non-conductive wireline 3. Wireline-conveyed communication assembly 40 is connected to said logging tool 50. Said logging tool and wireline-conveyed communication assembly 40 can be loaded within a lubricator assembly disposed over a wellbore (such as, for example, lubricator assembly 1 depicted in FIG. 1). While loaded within said lubricator assembly (and prior to being conveyed out of said lubricator assembly and into a well), data can be acquired by logging tool 50.

Data acquired by logging tool 50 can be transmitted to wireline-conveyed communication assembly 40. Such data transmission (also sometimes referred to as digital transmission or digital communication) comprises the transfer of data (typically a digital bit stream) over a point-to-point or point-to-multipoint communication channel. Examples of such channels include, without limitation, copper wires, optical fibers, wireless communication channels, and storage media.

Data acquired by logging tool 50 and transmitted to wireline-conveyed communication assembly 40 can then be wirelessly communicated from in-line communication sub 41 of said wireline-conveyed communication assembly 40 (using antenna 43) to communication sub 33 (using antenna 31) of surface communication assembly 10. Thereafter, data received by said communication sub 33 can then be downloaded, displayed and/or stored via external data port 32 of hammer union cap assembly 30. Such data can be acquired from said external data port 32 using a wired connection or wireless transmitter (not depicted in FIG. 4).

Data acquired from said logging tool 50 can be sampled to test operational functionality of said logging tool 50 prior to conveying said logging tool 50 into a well. By way of illustration, but not limitation, a ‘snapshot’ image can be acquired at or near a well's surface to confirm that a lens of a camera or video logging tool is not dirty or otherwise obscured. Such verification prior to conveying a camera or video logging tool in a well yields a higher chance of a successful operation. After such verification, logging tool 50 can be lowered into a well via wireline 3.

After a logging operation is performed and down hole data or other information is acquired using logging tool 50, said logging tool 50 can be retrieved into a surface lubricator assembly. As depicted in FIG. 4, for optimal communication conditions, wireline antenna 43 is positioned in alignment with surface antenna 31. With valve assembly 20 open, a substantially direct and unobstructed line of sight exists between antennas 31 and 43. If required, valve assembly 20 can be closed to provide a fluid-pressure barrier to permit removal of hammer union antenna cap assembly 30.

Data acquired by logging tool 50 is transmitted to wireline-conveyed communication assembly 40. Such data can then be wirelessly communicated from said wireline-conveyed communication assembly 40 (using antenna 43) to communication sub 33 (using antenna 31) of surface communication assembly 10. Thereafter, data received by said communication sub 33 can be acquired, displayed and/or stored via external data port 32 of hammer union cap assembly 30. Such data can be obtained from said externally accessible data port 32 using a wired connection or wireless transmitter. Importantly, said data from logging tool 50 can be transferred to a display and/or data storage device prior to disassembling a lubricator assembly and physically accessing logging tool 50. In this manner, an operator can verify that acquired visual images and/or other logged data has been properly acquired and/or recorded.

In a preferred embodiment, the flow of data described above can also occur in reverse sequence. Specifically, operational instructions or other data can be input via externally accessible data port 32 using a wired connection or wireless receiver. Such input data can then be wirelessly communicated from communication sub 33 (using antenna 31) of surface communication assembly 10 to in-line communication sub 41 of wireline-conveyed communication assembly 40 (using antenna 43). Data acquired by wireline-conveyed communication assembly 40 can then be transmitted to logging tool 50; such input data can include, without limitation, software updates, operational commands and/or other data used by logging tool 50. Importantly, said input data can be imported, downloaded or otherwise transferred to logging tool 50 prior to disassembling a lubricator assembly and physically accessing logging tool 50.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

1. A method for transmitting data from a logging tool conveyed via non-conductive spooled conduit and disposed within a pressure containment assembly operationally attached to a wellbore comprising:
a) installing a communication assembly in said pressure containment assembly, wherein said communication assembly comprises:
i) a housing;
ii) a data receiver installed within said housing, wherein said data receiver is adapted to wirelessly receive data transmitted from within said pressure containment assembly;
b) wirelessly transmitting data acquired from said logging tool to said data receiver; and
c) accessing said transmitted data from said data receiver from a location outside said pressure containment assembly without removing said pressure containment assembly from said wellbore.

2. The method of claim 1, wherein said non-conductive conduit comprises slickline or coiled tubing.

3. The method of claim 1, wherein said logging tool is battery powered.

4. The method of claim 1, wherein said pressure containment assembly comprises a lubricator.

5. A method for transmitting data acquired by a logging tool comprising:
a) conveying said logging tool into a wellbore via non-conductive conduit;
b) acquiring data from within said wellbore using said logging tool;
c) retrieving said logging tool from said wellbore, wherein said logging tool is at least partially received within a pressure containment assembly operationally attached to said wellbore;
d) wirelessly transmitting said acquired data from said logging tool to a data receiver disposed within said pressure containment assembly; and
e) accessing said transmitted data from said data receiver from a location outside said pressure containment assembly without removing said pressure containment assembly from said wellbore.

6. The method of claim 5, wherein said non-conductive conduit comprises slickline or coiled tubing.

7. The method of claim 5, wherein said logging tool is battery powered.

8. The method of claim 5, wherein said pressure containment assembly comprises a lubricator.

9. The method of claim 5, wherein said transmitted data comprises at least one visual image.

10. A method for transmitting data acquired by a logging tool comprising:
a) installing a logging tool within a pressure containment assembly operationally attached to a wellbore;
b) acquiring data with said logging tool;
c) wirelessly transmitting said data acquired by said logging tool to a data receiver disposed within said pressure containment assembly; and
d) accessing said transmitted data from said data receiver from a location outside said pressure containment assembly without removing said pressure containment assembly from said wellbore.

11. The method of claim 10, wherein said step of wirelessly transmitting said data acquired by said logging tool to a data receiver disposed within said pressure containment assembly is performed prior to conveying said logging tool into said wellbore.

12. The method of claim 11, further comprising the step of confirming operational functionality of said logging tool using said transmitted data.

13. The method of claim 12, wherein said transmitted data comprises at least one visual image.

14. The method of claim 10, further comprising the step of conveying said logging tool into a wellbore via non-conductive conduit.

15. The method of claim 14, wherein said non-conductive conduit comprises slickline or coiled tubing.

16. The method of claim 10, wherein said logging tool is battery powered.

17. The method of claim 10, wherein said pressure containment assembly comprises a lubricator.

18. The method of claim 10, wherein said data receiver further comprises at least one antenna for receiving data transmitted from said logging tool.

19. The method of claim 10, wherein said logging tool further comprises at least one antenna for transmitting data to said data receiver.
